(19) United States
(12) Patent Application Publication
(10) Pub. No.: US 2025/0332821 A1
(43) Pub. Date: Oct. 30, 2025

(54) Removable Container for a Packaging Device of a Refillable Cosmetic Product and Packaging Device of a Refillable Cosmetic Product

(71) Applicants: Guerlain, Paris (FR); Knoll Printing & Packaging Inc., Woodbury, NY (US)

(72) Inventors: Éric MÉCHINEAU, Paris Cedex (FR); Sébastien Verwaerde, Paris Cedex (FR); Jeremy Cohen, Woodbury, NY (US)

(73) Assignees: Guerlain, Paris (FR); Knoll Printing & Packaging Inc., Woodbury, NY (US)

(21) Appl. No.: 19/187,546

(22) Filed: Apr. 23, 2025

(30) Foreign Application Priority Data
Apr. 25, 2024 (FR) 2404336

(51) Int. Cl. B32B 27/08; B32B 3/26; B32B 27/30; B32B 27/32

(52) U.S. Cl. CPC B32B 27/08; B32B 3/263; B32B 27/306; B32B 27/325; B32B 2250/05; B32B 2250/24; B32B 2307/7242; B32B 2307/7265; B32B 2439/40; B32B 2555/00

(57) ABSTRACT

A removable container for a cosmetic product is intended to be received in an outer shell of a cosmetic product packaging device. The removable container comprises a cup in a cellulose-based material, covered, on an inner face, intended to be oriented towards the cosmetic product, by a barrier film. The barrier film is adapted to limit or even prevent the migration of at least one component of the cosmetic product through the cup.

### TECHNICAL FIELD

The present disclosure relates to a removable container for a packaging device of a refillable cosmetic product and to a packaging device of a refillable cosmetic product comprising such a removable container. A refill of a cosmetic product comprising such a removable container is also described.

### PRIOR ART

Users are particularly sensitive to the esthetics of cosmetic product packaging devices. However, the cost of esthetic packaging devices is high and this increases the cost of cosmetic products sold in this form in commerce.

An idea has been developed consisting of providing an esthetic packaging device, including a separate removable container that is less esthetic, but which has less expensive packaging. Preferably, the container is removable so as to be able to refill the packaging device, by replacing the removable container.

This removable container is generally in plastic. However, such a container in plastic leads to ecological problems, particularly recycling, to which users are increasingly sensitive. Furthermore, the recycling standards of packaging devices are always stricter, which tends to limit or even preclude the use of plastic.

Moreover, EP-4 233 636 describes a container for a fluid or powdery substance comprising an external element made of glass and a internal element inserted into a mouth of the external element. At the mouth of the external element, the internal element comprises at least two perimeter swellings which, upon deforming at least elastically, fasten the internal element to the external one. The internal element can be made in a paper-based or card-board-based material. The internal element can comprise a lining or a coating of the paper-based or card-board-based material. The lining or coating can be in a plastic material, for example PE, PLA, HDPE, PP or with wax.

### SUMMARY

The present disclosure improves the situation. In particular, an object of the present disclosure is to propose a packaging device of a cosmetic product that is refillable and that does not present at least some of the abovementioned disadvantages.

For this purpose, a removable container for a cosmetic product is proposed, intended to be received in an outer shell of a packaging device of a cosmetic product, the removable container comprising a cup in a cellulose-based material, covered, on an inner face, intended to be oriented toward the cosmetic product, by a barrier film adapted to limit or even prevent the migration of at least one component of the cosmetic product through the cup. The barrier film may be multilayered. The barrier film may comprise at least five layers. One of the at least five layers may be made of cyclic olefin copolymer.

Preferably the removable container may comprise one or more of the following features, taken alone or in combination:
the cellulose-based material contains fibers from at least one from among bamboo, bagasse, wood, and recycled paper;
the cellulose-based material comprises a mixture of between 50 and 70% by weight of fibers, of bamboo fibers, particularly 60% by weight, and the complementary to 100% by weight of fibers, of bagasse fibers;
the barrier film comprises at least one layer in at least one from among polyethylene, polypropylene, polyamide, ethylene vinyl alcohol, ethylene vinyl acetate;
the barrier comprises exactly seven layers;
the barrier film comprises the seven following layers, from a first layer designed to be oriented towards the cosmetic product, to a seventh layer oriented towards the cellulose-based material of which the cup is made from:
   a first layer of polyethylene;
   a second layer of cyclic olefin copolymer;
   a third layer of chemical binder, particularly a layer of a polymer comprising ethylene or an olefin-based adhesion resin;
   a fourth layer of ethylene vinyl alcohol;
   a fifth layer of a chemical binder, particularly a layer of a polymer comprising ethylene or an olefin-based adhesion resin;
   a sixth layer of cyclic olefin copolymer; and
   a seventh layer of ethylene vinyl acetate;
the removable container furthermore comprises an inner seal closing the cup, the inner seal preferably being in aluminum or in an aluminum alloy, in a plastic material, in particular in polyethylene terephthalate or in polyethylene furanoate, or in paper, particularly in coated paper;
the inner seal is covered, on at least one inner face, intended to be oriented towards the cosmetic product inside the cup, by a coating impermeable to liquids and, preferably, impermeable to gases, the impermeable coating preferably containing an epoxy resin and a methacrylate olefin polymer;
the cup presents a bottom, an opening and a lateral wall between the bottom and the opening;
the lateral wall of the cup forms a flange, preferably substantially flat, extending between an inner edge, delimiting the opening of the removable container, and an outer edge, opposite from the inner edge, the flange preferably being at least partially covered by the barrier film;
the flange presents at least one from among a portion having a decreasing thickness in the direction of the outer edge of the flange and a thinning, near the outer edge;
the flange presents a thinning extending to the outer edge;
the flange presents a thinning, distant from the outer edge;
the inner seal is fixed, particularly bonded or welded, on the flange near a fixation area, the fixation area being disposed closer to the inner edge of the flange than the portion having decreasing thickness or the thinning, respectively;
the removable container comprises a plurality of swellings on the outer surface, the swellings preferably being equiangularly distributed on the removable container;
the at least one swelling is formed on the cup, particularly on the lateral wall of the cup;
the at least one swelling is formed on a shell in a cellulose-based material, particularly in the same material as the cup, the shell receiving the cup;
the shell forms a flange, the cup and the shell being fixed together at their respective flanges, particularly by bonding or welding;
the shell is covered, on a face oriented towards the cup, by a barrier film, the barrier film on the shell preferably being identical to the barrier film on the cup; and
the cup contains the cosmetic product; and
the lateral wall presents a shoulder near the opening of the cup.

According to another aspect, a refill is described of the cosmetic product comprising at least one removable container as described above, in all of its combinations, in a sealed envelope, preferably airtight, or in a case in cellulose or in molded cardboard.

According to still another aspect, a packaging device for a cosmetic product comprising an outer shell and a removable container such as described above, in all of its combinations, is described, the outer shell defining a compartment for receiving the removable container, the compartment for receiving the removable container opening at an outlet in the outer shell. The outer shell is preferably in one from among: glass, metal, ceramic, porcelain, crystal and plastic, particularly polymethyl methacrylate, polystyrene, polycarbonate, polyethylene terephthalate, ionomeric resin such as the ethylene vinyl copolymer known by the trade name Surlyn®, polyethylene, polypropylene, copolyester, natural stone, synthetic stone, wood, and urea formaldehyde.

The removable container may be held in position in the outer shell by deformation of at least one swelling of the removable container in contact with the outer shell, preferably at least two swellings of the removable container where appropriate, the removable container more preferably containing the cosmetic product.

Deformation of the at least one swelling of the removable container may be an elastic deformation.

Deformation of the at least one swelling of the removable container may be a plastic deformation.

The cosmetic product packaging device may furthermore comprise a lid able to close the outlet of the recess in the outer shell, even when a removable container is received in the recess in the outer shell, particularly by being fixed onto the outer shell.

The lid may be in one from among glass, metal, ceramic, porcelain, crystal, plastic, natural stone, synthetic stone, wood, and urea formaldehyde.

### BRIEF DESCRIPTION OF THE DRAWINGS

Other features, details and advantages will appear upon reading the detailed description below, and analyzing the attached drawings, in which:

FIG. 1 schematically represents a longitudinal cross-section view of a cosmetic product packaging device.

FIG. 2 schematically represents a longitudinal cross-section view of a sub-assembly of the cosmetic product packaging device of FIG. 1, the sub-assembly comprising an outer shell and a removable container.

FIG. 3 schematically represents in cross section a portion of the thickness of the cup of the removable container of FIG. 2, covered by an inner seal.

FIG. 4 schematically represents a front view of a first example of a removable container that can be employed in the packaging device of FIG. 1.

FIG. 5 schematically represents in perspective the removable container of FIG. 4.

FIG. 6 represents in longitudinal cross-section view a refill of the cosmetic product including the removable container of FIG. 4.

FIG. 7 represents a detail of a longitudinal cross-section view of a first example of a removable container fixed on the outer shell in a packaging device according to FIG. 1.

FIG. 8 represents a detail of a longitudinal cross-section view of a second example of a removable container fixed on the outer shell in a packaging device according to FIG. 1.

FIG. 9 represents a detail of a longitudinal cross-section view of a third example of a removable container fixed on the outer shell in a packaging device according to FIG. 1.

FIG. 10 illustrates a detail of a longitudinal cross-section view of a fourth example of a removable container that can be employed in a packaging device according to FIG. 1.

FIG. 11 represents a detail of a longitudinal cross-section view of a fifth example of a removable container fixed on the outer shell in a packaging device according to FIG. 1.

FIG. 12 represents a detail of a longitudinal cross-section view of a sixth example of a removable container fixed on the outer shell in a packaging device according to FIG. 1.

### DESCRIPTION OF EMBODIMENTS

In the rest of the description, elements that are identical or that have identical functions bear the same reference signs. For the sake of brevity in the present description, these elements are not described in detail in each example. On the contrary, only the differences between the different examples are described in detail.

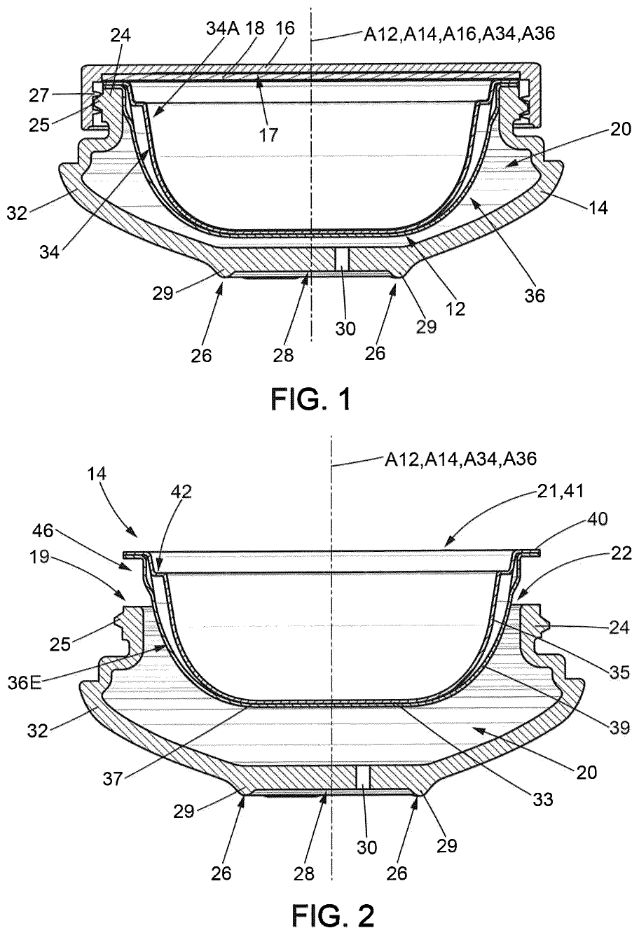

FIG. 1 illustrates an example of a refillable packaging device of a cosmetic product 10 (hereafter packaging device 10). This packaging device 10 essentially comprises a removable container 12 of cosmetic product, an outer shell 14 receiving the removable container 12, a lid 16 and a seal 18, here held to the lid 16.

The lid 16 is, in particular, in one from among glass, metal, ceramic, porcelain, crystal, plastic, natural stone, synthetic stone, ceramic, porcelain, wood, and urea formaldehyde. The lid 16 may be in several parts assembled together, particularly an outer body receiving an insert, the insert forming a means of fixation onto the outer shell, particularly a helical thread.

The seal 18 aims to prevent the cosmetic product P contained in the removable container 12 from drying out and/or prevent its volatile components from evaporating. The seal 18 is for example held tight between a bottom 17 of the lid 16 and an edge 19 of the outer shell 14, the seal closing an outlet 21 of the removable container 12.

More specifically, the outer shell 14 defines a recess 20 intended to receive, at least in part, the removable container 12. The recess 20 opens at an outlet 22 in the outer shell 14, surrounded by the edge 19.

The outer shell 14 also forms a collar 24, the free end of which forms the edge 19. The edge 19 extends around the outlet 22. The collar 24 here presents a helical thread 25, complementary to a thread 27 inside the lid 16. The lid 16 may thus be fixed to the outer shell 14 by screwing. Of course, other means of fixing the lid 16 onto the outer shell 14 are possible and accessible to the person skilled in the art. For example, the lid 16 may be snap-fitted (or “clipped”) onto the outer shell 14.

Here, the outer shell 14 is shaped to allow the outer shell 14 to be balanced on a flat support. As illustrated, the outer shell 14 rests on such a flat support by a bearing area 26 surrounding a bottom 28, recessed in comparison to the bearing area 26. In a variation, the bottom 28 is not recessed in comparison to the bearing area 26 but, on the contrary, forms part of this bearing area 26. The bearing area 26 has, for example, a closed contour, particularly a circular or elliptical, or any other shape, contour. Alternatively, the bearing area 26 is formed, as illustrated, by separate feet 29, of the outer shell 14, extending from the bottom 28 of the outer shell 14. The bottom 28 of the outer shell 14 may present, as illustrated, a through hole 30 opening firstly on the bottom 28, outside the outer shell 14, and, secondly, in the recess 20. The hole 30 may advantageously allow a finger to be inserted. To do this, the hole 30 may present a diameter of not more than 15 mm, preferably not more than 10 mm. Alternatively, however, the hole 30 has a size that does not allow a finger to be inserted, for example a diameter of less than 5 mm, preferably less than 2 mm. In this case in particular, the function of the hole 30 is to allow the air contained in the recess 20 to escape during assembly of the removable container 12 into the outer shell 14. Alternatively again, the bottom 28 lacks a hole 30.

According to an embodiment that is not represented, the flat bottom 28 of the outer shell 14 is at least partially covered by a label, the label may or may not cover the hole 30. The label may, for example, bear any information relating to the product brand and/or its composition and/or its method of application and/or its possible expiration date.

Between the bottom 28 and the edge 24 around the outlet 22, the outer shell 14 here forms a lateral wall 32 that is at least in part tubular. The part of the lateral wall 32 near the flange 19 forms the collar 24. The lateral wall 32 is rotationally symmetrical about a main axis of extension A14 of the outer shell 14 (hereafter the axis A14 of the outer shell 14), preferably fully rotationally symmetrical. Of course, this shape of the outer shell 14 is not limiting, it may present substantially any shape, particularly any shape aiming to ensure the esthetics of the packaging device 10. For example, the outer shell 14 may form, between the bottom 28 and the flange 19, a lower portion, near the bottom 28, that is parallelepipedic and an upper portion, near the flange 19, that is tubular, particularly having a general rotationally symmetrical shape about the axis A14 of the outer shell 14, preferably fully rotationally symmetrical.

The outer shell 14 is preferably opaque. This confers an esthetic effect appreciated by users to the outer shell 14 and to the packaging device 10. The outer shell 14 may alternatively be at least partially translucent and/or may present portions that are at least partially translucent.

The outer shell 14 may particularly be made in one from among: glass, metal, ceramic, porcelain, crystal and plastic, particularly polymethyl methacrylate, polystyrene, polycarbonate, polyethylene terephthalate, ionomeric resin such as the ethylene vinyl copolymer known by the trade name Surlyn®, polyethylene (PE), polypropylene (PP), copolyester, natural stone, synthetic stone, wood, and urea formaldehyde. Preferably, the outer shell 14 is in glass, still preferably tinted glass, particularly lacquered glass. In a remarkable manner, the removable container 12 is in a material that is sufficiently flexible to be adapted to outer shells 14 presenting relatively high manufacturing tolerances. Therefore, a large number of different materials may be implemented for making the outer shell 14.

In addition, the removable container 12 here comprises a cup 34 and a shell 36, fixed together, the shell 36 forming a recess at least in part receiving the cup 34.

The cup 34 is in a cellulose-based material. The cup 34 is covered, on an inner face 34A, intended to be oriented towards the cosmetic product, by a barrier film 38. Preferably, the barrier film 38 covers the totality of the inner face 34A of the cup 34, particularly the inner face 34A of the cup 34 that would otherwise be in contact with the cosmetic product P. Therefore, the cosmetic product contained in the removable container 12 is preferably in contact with the barrier film 38 but not with the cellulose-based material of which the cup 34 is made.

The function of the barrier film 38 is to limit or even prevent the migration of at least one component of the cosmetic product outside of the removable container 12, through the wall of the cup 34. The barrier film 38 is therefore preferably impermeable to at least one from among water, oils, volatile molecules such as silicones, short-chain alkanes, and gases. “Short-chain alkanes” here refers to alkanes comprising between nine and fifteen carbon atoms.

The cosmetic product P is, for example, a cream, an emulsion, a lotion, a gel or an oil for the skin, particularly for the body, hands, face, eye contours, and/or the feet, a foundation, particularly a liquid foundation, a beauty mask, a soap, a deodorant soap, a perfume, an eau de toilette, an eau de Cologne, a bath and/or shower preparation, a hair care product, such as a hair dye, a bleach, a wavy hair treatment, a hair relaxer, a cleaning styling setting treatment, a hair care treatment, particularly in the form of a lotion, a cream, an oil, a styling treatment, particularly in the form of a lotion, hair spray, brilliantine, a cleaning product, particularly in the form of a lotion or a shampoo, a shaving product, particularly shaving foam or lotion, a make-up product, particularly an eye make-up product, such as a mascara, a product for removing make-up from the face and/or the eyes, a product intended to be applied on the lips, such as a lipstick, a lip gloss or a lip balm, a product for the care and painting of the nails, a suncare product, a sunless tanning product, a skin whitening product, an anti-wrinkle product. The cosmetic product may particularly be in the form of a liquid, cream, gel, paste, powder, or one-piece solid. The cosmetic product P may also be biphasic. For example, the cosmetic product P comprises suspensions, particularly suspensions that are solid, in a liquid phase, in the form of a cream or a gel.

The cellulose-based material of which the cup 34 is made may contain fibers from at least one from among bamboo, bagasse, wood and recycled paper. The cellulose-based material may particularly comprise a mixture of these fibers. In particular, the cellulose-based material may comprise a mixture of between 50 and 70% by weight of fibers, of bamboo fibers, particularly 60% by weight, and the complementary to 100% by weight of fibers, of bagasse fibers.

The material of which the cup 34 is made may also comprise a dye, particularly in the form of pigments of one or more different colors, and/or at least one anti-moisture agent. A n anti-moisture agent is, for example, an Alkyl Ketene Dimer (AKD). The weight proportion of dyes and of anti-moisture agent may be less than 10% of the weight of the material of which the cup is made. For example, the weight proportion of anti-moisture agent may be between 1% and 5%, preferably between 2% and 2.5%. The weight proportion of dyes, particularly pigments, may then be less than 7.5%, particularly less than 5%.

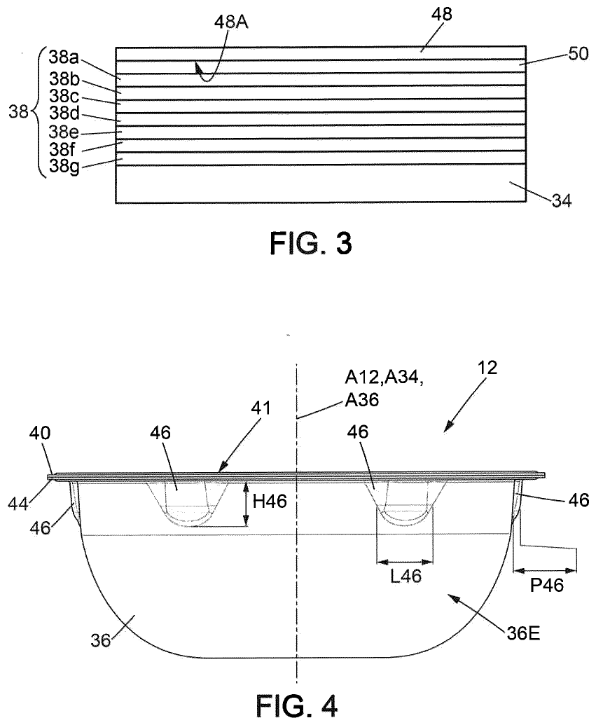

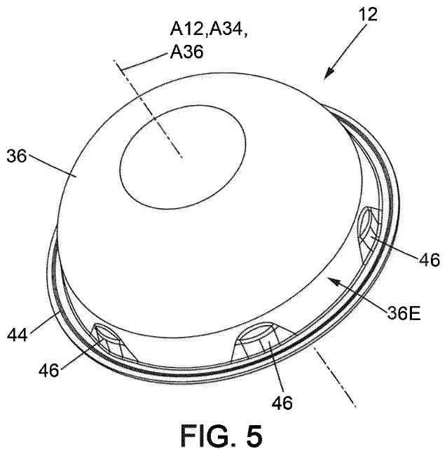

The barrier film 38 is in at least one from among polyethylene (PE), polypropylene (PP), polyamide (PA), ethylene vinyl alcohol (EVOH), ethylene vinyl acetate (EVA), cyclic olefin copolymer (COC). The barrier film 38 may be multilayered. The barrier film 38 may comprise at least five layers. The barrier film 38 may particularly comprise exactly seven layers 38a-38g, particularly, as illustrated in FIG. 3, the seven following layers 38a-38g, from layer 38a oriented towards the cosmetic product contained in the removable container 12, to layer 38g oriented towards the cellulose-based material of which the cup 34 is made from:
a first outer layer 38a, of polyethylene (PE);
a second layer 38b of cyclic olefin copolymer (COC);
a third layer 38c of chemical binder, particularly a layer of a polymer comprising ethylene or an olefin-based adhesion resin;
a fourth layer 38d of ethylene vinyl alcohol (EVOH);
a fifth layer 38e of a chemical binder, particularly a layer of a polymer comprising ethylene or an olefin-based adhesion resin;
a sixth layer 38f of cyclic olefin copolymer (COC); and
a seventh inner layer 38g, of ethylene vinyl acetate (EVA).

The more layers the film barrier 38 contains, the more it is a priori effective. However, a high number of layers implies a significant thickness of the film barrier 38 which may then be difficult to apply to the cup 34, particularly by lamination. Air bubbles may be trapped between the film barrier 38 and the cup 34, which damages the appearance of the removable container 12 and/or the effectiveness of the film barrier 38.

The cup 34 has a general bowl shape, here rotationally symmetrical about its axis of symmetry A34 (hereafter axis of the cup 34) intended to correspond to the axis A14 of the outer shell 14 when the removable container 12 is fixed on the outer shell 14. Thus, cup 34 presents a bottom 33, here substantially flat, preferably normal to the axis A34 of the cup 34, and a lateral wall 35. The lateral wall 35 forms a flange 40. The flange 40 extends between an inner edge 40i, surrounding the outlet 41 of the cup 34 and an outer edge 40e, here free, opposite the inner edge 40i. The outlet 41 of the cup 34 corresponds to the outlet 21 of the removable container 12. In addition, cup 34 presents a shoulder 42 near flange 40. Here it is noted that cup 34 presents a regular inner surface, lacking concave reliefs, with the exception of shoulder 42. It seems preferable to limit or even prevent the presence of such concave reliefs which are likely to be filled with cosmetic product P that is difficult to remove. Such concave reliefs may thus lead to a waste of cosmetic product P contained in the removable container 12, which upsets the users of the cosmetic product packaging device 10.

For example, cup 34 is molded. The thickness of the layer of cellulose-based material forming the cup 34 may be substantially constant over a majority of the cup 34. The thickness of the layer of cellulose-based material may particularly be equal to or greater than 0.4 mm, preferably 0.5 mm and/or less than or equal to 1 mm, preferably 0.8 mm. The thickness of the layer of cellulose-based material is, for example, equal to 0.65 mm. Alternatively, the thickness of the layer of cellulose-based material may vary. For example, the flange 40 may have a maximum thickness greater than the thickness of the rest of the lateral wall 35 of the cup 34.

In addition, the shell 36 has a general bowl shape, here rotationally symmetrical about its axis of symmetry A36 (hereafter axis of the shell 36) corresponding to the axis A34 of the cup 34 when the cup 34 and the shell 36 are fixed together. Thus, shell 36 presents a bottom 37, here substantially flat, preferably normal to the axis A36 of the shell 36, and a lateral wall 39. The lateral wall 39 of the shell 36 forms a flange 44. The flange 44 extends between an inner edge 44i, surrounding the outlet of the cup 36 and an outer edge 44e, here free, opposite the inner edge 44i.

The shell 36 thus forms a recess receiving the cup 34. The flange 44 of the shell 36 is here fixed to the flange 40 of the cup 34 to fix the cup 34 and the shell 36 together. For example, the flange 44 of the shell 36 is bonded to the flange 40 of the cup 34, particularly on a surface of the flange 40 of the cup 34 that is not covered by the film 38. Preferably, the cup 34 and the shell 36 are fixed together only through their respective flanges 40, 44. Particularly, a space is held free between the lateral walls 35, 39 of the cup 34 and the shell 36. The bottoms 33, 37 of the cup 34 and of the shell 36 may be distant. Alternatively, the bottoms 33, 37 of the cup 34 and of the shell 36 are in contact, preferably without being fixed together.

The shell 36, particularly the lateral wall 39 of the shell 36, here presents a relief 46 projecting from its outer surface 36E, oriented opposite to the cup 34. The at least one relief 46 is preferably formed by a variation in the shape of the lateral wall 39 rather than by a local variation in the thickness of the lateral wall 39. The at least one relief 46 preferably presents a width equal to only one portion of the perimeter of the lateral wall 35, around the axis A12 of the removable container 12. In other words, the at least one relief 46 preferably does not take the form of a swelling or a bead extending on an entire perimeter of the lateral wall 35.

The shell 36 preferably presents a plurality of reliefs 46, particularly at least two such reliefs 46, preferably at least three reliefs 46, more preferably at least four reliefs 46, more preferably at least five reliefs 46 and even more preferably at least six reliefs 46, as illustrated in the figures. Here the reliefs 46 are regularly angularly distributed around the axis A36 of the shell 36. The reliefs 46 here take the form of swellings of the wall of the shell 36. The reliefs 46 are here formed near the flange 44 of the shell 36. The reliefs 46 are preferably opening in the direction of the shell 36, to facilitate the unmolding of the shell 36.

Each relief 46 presents, for example:
a height H46, measured along the direction of the axis A36 of the shell 36, of between 5 mm and 10 mm, particularly equal to 7.5 mm; and/or
a width L46 at mid-height, of between 5 and 10 mm, particularly equal to 9 mm; and/or
a depth P46 of between 0.75 and 2 mm, particularly equal to 1.2 mm.

The shell 36 is preferably in a flexible material, particularly more flexible than the material in which the outer shell 14 is made. The shell 36 is, for example, in a cellulose-based material similar to that of the cup 34, such as described previously, preferably in the same cellulose-based material as that in which the cup 34 is made. According to one example, shell 36 is not covered, on any of its faces, by a barrier film similar to the barrier film 38 covering the inner face 34A of the cup 34, such as described previously. Indeed, such a film may not be useful, the shell 36 not being intended to be in contact with the cosmetic product contained in the removable container 12.

For example, shell 36 is molded. The thickness of the layer of cellulose-based material may be substantially constant over a majority of the shell 36. The thickness of the layer of cellulose-based material of which the shell 36 is made may particularly be equal to or greater than 0.4 mm, preferably 0.5 mm and/or less than or equal to 1 mm, preferably 0.8 mm. The thickness of the layer of cellulose-based material is, for example, equal to 0.65 mm. Alternatively, the thickness of the layer of cellulose-based material of which the shell 36 is made may vary. For example, the flange 44 may have a maximum thickness greater than the thickness of the rest of the lateral wall 39 of the shell 36. Alternatively or in addition, the thickness of the lateral wall 39 of the shell 36 may be less at the reliefs 46. The thickness of the lateral wall 39 of the shell 36 may particularly be equal to 0.6 mm at the reliefs 46.

The removable container 12 is shaped to be received in the recess 20 inside the outer shell 14, such that the flange 44 of the shell 36 rests on the edge 19 around the outlet of the outer shell 14. The removable container 12 is here held in position in the recess 20 inside the outer shell 14 by deformation of at least one relief 46 of the shell 36. Preferably, at least two reliefs 46, or even all the reliefs 46 are deformed in contact with the outer shell 14 when the removable container is fixed in the recess 20 inside the outer shell 14. To do this, for example:
the flanges 40, 44 rest on the free end of the collar 24 surrounding the outlet 22 of the recess 20 in the outer shell 14, for example by choosing a diameter of the flanges 40, 44 of the cup 34 and of the shell 36 greater than the diameter of the outlet 22 of the recess 20 in the outer shell 14, particularly substantially equal to the diameter of the collar 24;
a space is maintained between the collar 24 and the outer shell 14 and the lateral wall 39 of the shell 36 exclusive of reliefs 46, for example by choosing a diameter exclusive of reliefs 46 of the lateral wall 39 of the shell 36 of less than the diameter of the outlet 22 of the recess 20 in the outer shell 14; and
the reliefs are in contact with the collar 24 of the outer shell 14, for example by choosing a diameter of the lateral wall 39 of the shell 36 at the reliefs 46 greater, at least locally, than the diameter of the outlet 22 of the recess 20 in the outer shell 14. Preferably, the diameter of the lateral wall 35 of the cup 34 is chosen to be less than the diameter of the outlet 22 of the recess 20 in the outer shell 14 to prevent deformation of the cup 34 received in the outer shell 14.

The deformation of each relief 46 may be elastic and/or plastic. Preferably, the deformation of each relief 46 is elastic, to enable the removable container 12 in an outer shell 14 to be removed and put back into place. Preferably, as illustrated in FIG. 7, the cup 34, is not deformed when the removable container 12 is received in the outer shell 14, only the shell 36 is deformed, mainly at the reliefs 46. In this way the appearance is prevented of reliefs on the lateral wall 35 of the cup 34, which could damage the proper removal of the cosmetic product, by creating pockets that are difficult to empty.

Removal of the removable container 12 outside of the outer shell 14 may particularly be done by pulling on the flange of the removable container 12. In particular, a blade and/or a nail may be placed between the flange of the removable container 12 and the edge 24 of the outer shell 14, to facilitate the handling of the removable container 12 necessary for its removal outside of the outer shell 14.

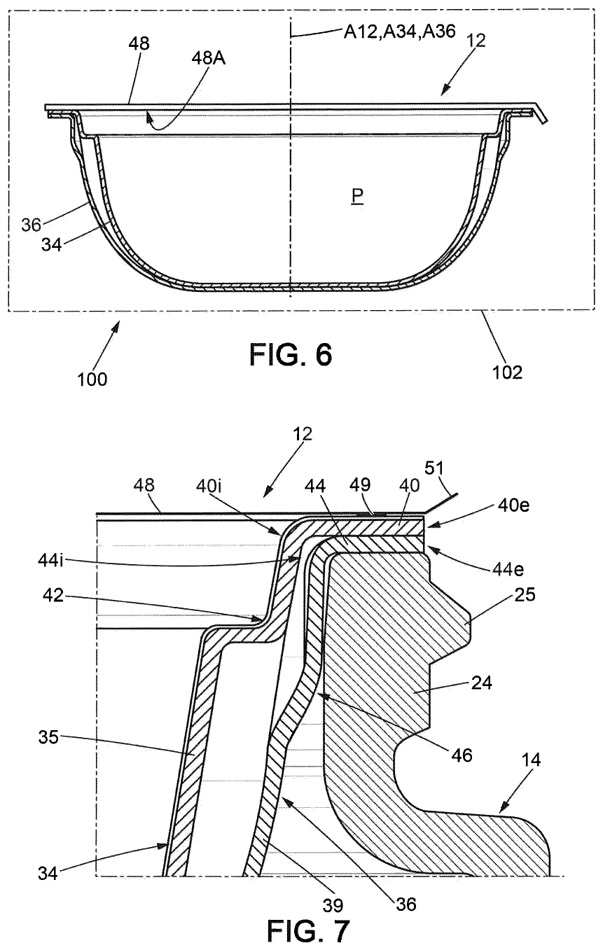

In addition, as illustrated in FIG. 3 or in FIG. 6, in particular, the removable container 12 may further comprise an inner seal 48 to close, preferably impermeably to liquids and, more preferably, to gases, the outlet 41 of the cup 34 before its first use. In particular, the removable container 12 may comprise such an inner seal 48 in the packaging device 10 before its first use, or in a refill 100 of cosmetic product P including such a removable container 12 closed by the inner seal 48, received in a sealed envelope 102. According to a first example, the envelope 102 may be sealed so as to be impermeable to liquids and preferably to gases. Alternatively, the envelope 102 is a packaging, particularly a case, in cellulose or in cardboard, preferably molded.

The inner seal 48 is, for example, in aluminum or in an aluminum alloy, in a plastic material, particularly in polyethylene terephthalate (or PET) or in polyethylene furanoate (or PEF) or else in paper, particularly in coated paper.

As illustrated in FIG. 3, the inner seal 48 may be covered on at least one lower face 48A, intended to be oriented towards the cosmetic product contained in the cup 34, by an impermeable coating 50, particularly a coating impermeable to liquids, preferably to gases. The coating 50 contains, for example, an epoxy resin and a methacrylate olefin polymer. The coating 50 here preferably has a double function of protecting the cosmetic product by preventing direct contact of the cosmetic product with the inner seal 48, while allowing, or even supporting, the fixation of the inner seal 48 onto the cup 34, particularly by welding or bonding.

The inner seal 48 is preferably flexible, particularly more flexible than the cup 34. The inner seal 48 is, for example, stretched over the outlet 41 of the cup 34.

The inner seal 48 is preferably fixed to the flange 40, at a fixation area 49. The fixation area 49 corresponds to one portion only of the surface of the flange 40 of the cup 34, covered with film 38. The fixation area 49 has, for example, an annular shape. The width of the fixation area 49 may be equal to or greater than 1 mm and/or less than or equal to 5 mm, particularly equal to 2 mm. The inner seal 48 is, for example, welded, particularly welded by ultrasound, at the flange 40, on the fixation area 49. The inner seal 48, particularly a tab 51 formed by the inner seal 48, may extend beyond the flange 40 of the cup 34, free in comparison to the cup 34. This tab 51 may facilitate the gripping and handling of the inner seal 48, particularly necessary for the removal of the inner seal 48 from the cup 34.

To limit the risks of delamination of the film 38 during this removal of the inner seal 48 from the cup 34, the flange 40 of the cup 34 presents a geometry adapted to limit or even negate the tangential stresses exerted by the inner seal 48 on the film 38 covering the cup 34, during the removal of the inner seal 48, which tend to embed the film 38 with the inner seal 48 and, thus, delaminate the film 38 from the cup 34.

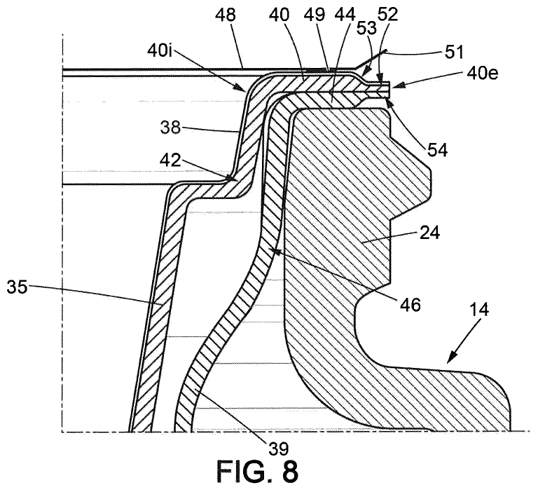

Thus, as illustrated in FIG. 8, the flange 40 of the cup 34 presents a thinning 52 in the form of an outer annular portion of reduced thickness, particularly in comparison to an inner annular portion of the flange 40. Here, for example, the thinning 52 is formed by an outer portion, the thickness of which is substantially half that of the thickness of the rest of the flange 40. Alternatively or in addition, the thickness of the outer portion forming the thinning 52 is between 0.2 mm and 0.5 mm, particularly it is equal to 0.365 mm. Here, the thinning 52 extends to the free outer edge 40e, of the flange 40. In this case, the flange 40 of the cup 34 also comprises a transition portion 53 of variable thickness, particularly of decreasing thickness towards the outer edge 40e of the flange 40, between the portion of reduced thickness 52 and the lower portion, of greater thickness, here with a substantially frustoconical shape. In this transition portion 53, the fixation force of the barrier film 38 on the flange 40 tends to oppose the tensile forces exerted by the inner seal 48 on the barrier film 38 when the inner seal 48 is removed from the cup 34, limiting or even preventing the risks of delamination of the barrier film 38.

For ease of fabrication of the removable container 12, the flange 44 of the shell 36 may also comprise a thinning 54 in the form of a portion of reduced thickness. The thinning 54 of the flange 44 of the shell 36 may be arranged level with the thinning 52 of the flange 40 of the cup 34. In fact, the thinnings 52, 54 of the flanges 40, 44 may be formed simultaneously, by pinching, once the cup 34 is fixed in the shell 34. Also in this case, the thinning 54 forms a transition portion 53, the thickness of which decreases towards the outer edge 40e of the flange 40, enabling the risks of delamination of the barrier film 38 during removal of the inner seal 48 to be limited, as explained previously.

It should be noted here that the thickness of the barrier film 38 covering the inner face 34A of the cup 34 and, here, the upper free face of the flange 40, may be substantially constant over the entire flange 40 of the cup 34, the pinching mentioned previously being substantially without effect on the barrier film 38. The thickness of the barrier film is, for example, of between 0.1 mm and 0.5 mm, particularly equal to 0.2 mm.

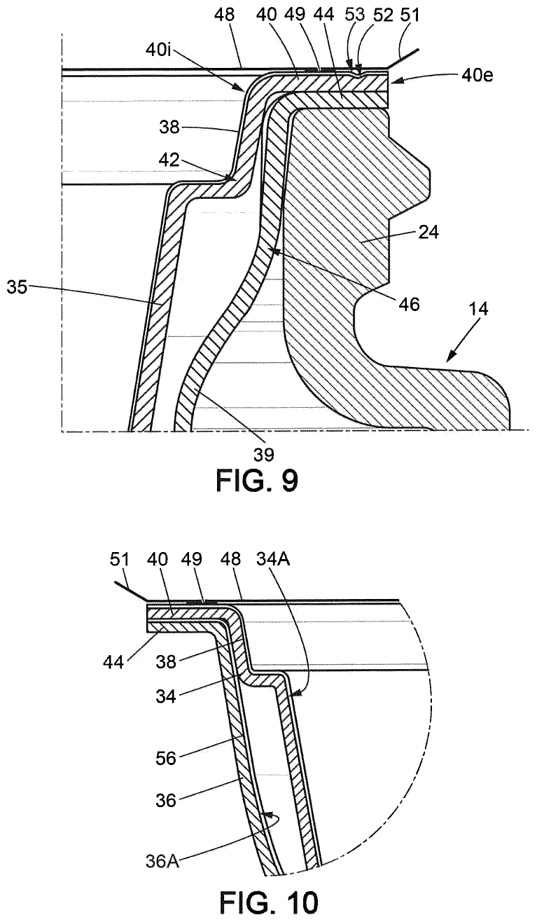

According to another example, illustrated in FIG. 9, the thinning 52 of the flange 40 is distant from the free outer edge 40e, of the flange 40. Therefore, the thinning 52 of the flange 40 may form a groove on the free face of the flange 40 of the cup 34.

Here, the groove may be formed on the flange 40 of the cup 34 before fixation of the cup 34 in the shell 36. Thus, the shell 36 may lack the thinning 54 of the flange 44 level with the thinning 52 of the flange 40 of the cup 34.

It should be noted that in the two cases (from FIG. 8 and from FIG. 9), the thinning 52 is arranged radially outwards in comparison to the fixation area 49 of the inner seal 48 on the flange 40.

FIG. 10 illustrates a second example of a removable container 12, which differs from the first example described previously in that the shell 36 is covered on an inner face 36A by a barrier film 56. The barrier film 56 is preferably impermeable to liquids and, more preferably, to gases. Thus, the barrier film 56 may further reduce the risks of migration of components from the cosmetic product P contained in the removable container 12, through the cup 34 and the shell 36. The barrier film 56 may be similar or even identical to the barrier film 38 covering the inner face 34A of the cup 34.

Furthermore, in the example illustrated in FIG. 10, the flanges 40, 44 of the cup 34 and of the shell 36 do not present thinnings 52, 54, respectively. However, the flanges 40, 44 may present a thinning 52, 54 as illustrated in FIG. 8 or FIG. 9.

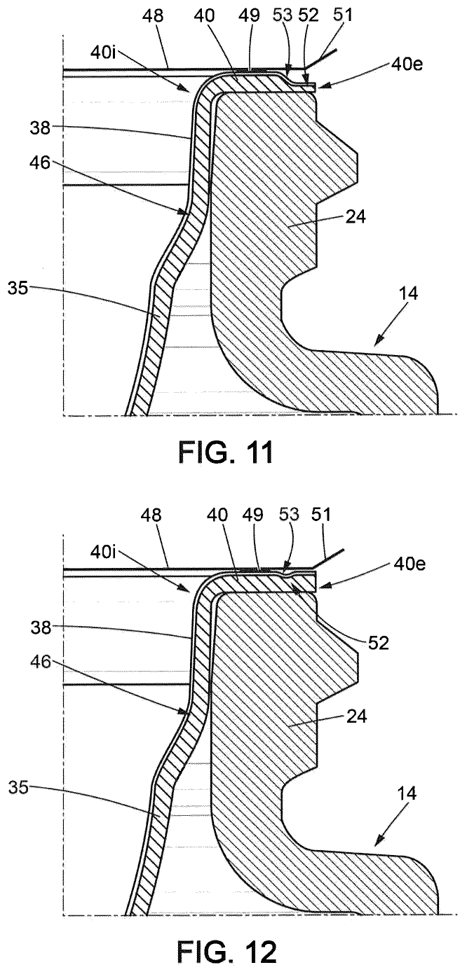

Lastly, FIG. 11 and FIG. 12 illustrate variations of FIG. 8 and FIG. 9, respectively, in which the removable containers 12 are each time constituted of a single cup 34. In other words, each removable container 12 illustrated in FIG. 11 and in FIG. 12 is lacking a shell 36. In this case, the cup 34 presents reliefs 46 adapted to be deformed in an elastic and/or plastic manner, to maintain the removable container 12 in the outer shell 14. The reliefs 46 are then similar to those formed on the shell 36, previously described. Also in this case, the reliefs 46 are deformed during insertion of the removable container 12 in the outer shell 14.

However in this case, the cup 34 is similar to the cup 34 from the examples previously described, but may present a substantially greater thickness. Thus, in particular, the thickness of the layer of cellulose-based material may be substantially constant over a majority of the cup 34. The thickness of the layer of cellulose-based material may particularly be equal to or greater than 0.5 mm, preferably equal to or greater than 0.8 mm and/or less than or equal to 1.6 mm, preferably less than or equal to 1.5 mm. The thickness of the layer of cellulose-based material may alternatively vary. In particular, the thickness of the layer of cellulose-based material may be reduced at the reliefs 46.

As illustrated, in addition, the cup 34 of each removable container 12 illustrated in FIG. 11 and in FIG. 12 may have a flange 40 with a thinning 52 identical to the thinning 52 present on the flange 40 of the cup 34 from the examples described previously.

The invention is not limited to only the embodiments described above with regard to the figures, but is, on the contrary, subject to numerous variations accessible to the person skilled in the art. In particular, the features of the different embodiments described may be combined in embodiments not illustrated in the figures.

Furthermore, in the examples described, the bottom of the removable container 12 is substantially flat. However, the bottom of the removable container 12 may take other forms. In particular, the bottom may present a relief such as a pin for example, not allowing the removable container to be placed flat on a flat support. Such a pin then requires the use of the outer shell 14 to receive the removable container 12, to be able to use the removable container 12, particularly to collect the cosmetic product contained in the removable container 12, by preventing it from turning over. According to another variation, the bottom of the removable container is rounded.

1. A removable container for a cosmetic product, intended to be received in an outer shell of a packaging device of a cosmetic product, the removable container comprising a cup in a cellulose-based material, covered, on an inner face, intended to be oriented toward the cosmetic product, by a barrier film adapted to limit or even prevent the migration of at least one component of the cosmetic product through the cup, wherein the barrier film is multilayered, the barrier film comprising at least five layers.

2. The removable container according to claim 1, wherein the cellulose-based material contains fibers from at least one from among bamboo, bagasse, wood, and recycled paper.

3. The removable container according to claim 2, wherein the cellulose-based material comprises a mixture of between 50 and 70% by weight of fibers, of bamboo fibers, particularly 60% by weight, and the complementary to 100% by weight of fibers, of bagasse fibers.

4. The removable container according to one of claim 1, wherein the barrier film comprises at least one layer in at least one from among cyclic olefin copolymer, polyethylene, polypropylene, polyamide, ethylene vinyl alcohol, ethylene vinyl acetate.

5. The removable container according to one of claim 1, wherein the barrier film comprises exactly seven layers.

6. The removable container according to claim 5, wherein the barrier film comprises the seven following layers, from a first layer designed to be oriented towards the cosmetic product, to a seventh layer oriented towards the cellulose-based material of which the cup is made from:
a first layer of polyethylene;
a second layer of cyclic olefin copolymer;
a third layer of chemical binder, particularly a layer of a polymer comprising ethylene or an olefin-based adhesion resin;
a fourth layer of ethylene vinyl alcohol;
a fifth layer of a chemical binder, particularly a layer of a polymer comprising ethylene or an olefin-based adhesion resin;
a sixth layer of cyclic olefin copolymer; and
a seventh layer of ethylene vinyl acetate.

7. The removable container according to claim 1, furthermore comprising a seal closing the cup.

8. The removable container according to claim 7, wherein the seal is covered, on at least one inner face, intended to be oriented towards the cosmetic product inside of the cup, by a coating impermeable to at least one among liquids and gases.

9. The removable container according to claim 1, wherein the cup presents a bottom, an opening and a lateral wall between the bottom and the opening.

10. The removable container according to claim 9, wherein the lateral wall of the cup forms a flange, extending between an inner edge, delimiting the opening of the removable container, and an outer edge, opposite from the inner edge.

11. The removable container according to claim 10, wherein the flange presents at least one from among a portion of decreasing thickness in the direction of the outer edge of the flange and a thinning, near the outer edge.

12. The removable container according to claim 11, wherein the flange presents a thinning extending to the outer edge.

13. The removable container according to claim 11, wherein the flange presents a thinning, distant from the outer edge.

14. The removable container according to claim 11, wherein the removable container comprises a seal closing the cup and wherein the seal is fixed on the flange at a fixation area, the fixation area being arranged closer to the inner edge of the flange than the portion of decreasing thickness or the thinning, respectively.

15. The removable container according to claim 1, presenting at least one swelling on an outer surface, intended to be oriented opposite the cosmetic product.

16. The removable container according to claim 15, comprising a plurality of swellings on the outer surface.

17. The removable container according to claim 15, wherein the at least one swelling is formed on the cup.

18. The removable container according to claim 15, wherein the at least one swelling is formed on a shell in a cellulose-based material.

19. The removable container according to claim 18, wherein the cup presents a bottom, an opening and a lateral wall between the bottom and the opening, wherein the lateral wall of the cup forms a flange, extending between an inner edge, delimiting the opening of the removable container, and an outer edge, opposite from the inner edge, and wherein the shell forms a flange, the cup and the shell being fixed together at their respective flanges.

20. The removable container according to claim 18, wherein the shell is covered, on a face oriented towards the cup, by a barrier film.

21. The removable container according to claim 1, wherein the cup contains the cosmetic product.

22. A cosmetic product packaging device comprising an outer shell and a removable container according to claim 1, the outer shell defining a recess for receiving the removable container, the recess for receiving the removable container opening at an outlet in the outer shell.

23. The cosmetic product packaging device according to claim 22, the removable container presenting at least one swelling on an outer surface, intended to be oriented opposite the cosmetic product, wherein the removable container is maintained in position in the outer shell by deformation of at least one swelling of the removable container in contact with the outer shell.

24. The cosmetic product packaging device according to claim 23, wherein the deformation of the at least one swelling of the removable container is an elastic deformation.

25. The cosmetic product packaging device according to claim 23, wherein the deformation of the at least one swelling of the removable container is a plastic deformation.

26. The cosmetic product packaging device according to claim 23, furthermore comprising a lid able to close the outlet of the recess in the outer shell, even when a removable container is received in the recess in the outer shell.

27. A cosmetic product refill comprising at least one removable container according to claim 21, in at least one among a sealed envelope and a case in at least one among cellulose and molded cardboard.
